(19) United States
(12) Patent Application Publication
(10) Pub. No.: US 2016/0306117 A1
(43) Pub. Date: Oct. 20, 2016

(54) TAPERED POLYMER WAVEGUIDE

(71) Applicants: Christopher Middlebrook, Houghton, MI (US); Kevin Kruse, Oconto Falls, WI (US)

(72) Inventors: Christopher Middlebrook, Houghton, MI (US); Kevin Kruse, Oconto Falls, WI (US)

(21) Appl. No.: 14/940,487

(22) Filed: Nov. 13, 2015

Related U.S. Application Data
(60) Provisional application No. 62/149,182, filed on Apr. 17, 2015.

(51) Int. Cl. G02B 6/30; G02B 1/04

(52) U.S. Cl. CPC G02B 6/305; G02B 1/045

(57) ABSTRACT

A tapered optical waveguide includes a tapered waveguide section formed of a polymer. The tapered waveguide section has an optical fiber coupling end and a waveguide coupling end opposite the optical fiber coupling end with each of the optical fiber coupling end and the waveguide coupling end being generally planar. The optical fiber coupling end has a larger area than the waveguide coupling end to define a horizontal and vertical taper between the optical fiber coupling end and the waveguide coupling end. An optical system incorporating the tapered polymer waveguide is also disclosed.

### CROSS-REFERENCE TO RELATED APPLICATION

This application claims priority to U.S. Provisional Application Ser. No. 62/149,182, filed Apr. 17, 2015, entitled “Bi-Metallic Multi-Layer Waveguide Taper,” the contents of which are hereby incorporated by reference.

### TECHNICAL FIELD

This disclosure relates generally to optical communications systems and, more particularly, to a tapered polymer waveguide to compensate for components that have different optical mode sizes.

### BACKGROUND

Silicon waveguides are used as high bandwidth optical communication channels (e.g., k=1300-1600 nm) within integrated devices and are readily fabricated using traditional semiconductor manufacturing techniques. The high refractive index of silicon (e.g., n=3.5) ensures strong confinement of light within single mode waveguides that are typically a few hundred nanometers in size.

Silica-based single mode optical fibers are typically used as an optical interconnection method of coupling light into and out of the silicon waveguides of the integrated devices due to their ease of handling, flexibility, low loss, and high bandwidth capability. Direct coupling between silicon waveguides (e.g., NA>3.0) and single mode fibers (e.g., NA<0.15) typically results in high coupling loss (e.g., r_{C}=18.8 dB) due to the modal size and numerical aperture (NA) mismatch.

Silicon waveguide gratings are sometimes used to couple a silicon waveguide to a single mode optical fiber. In one example, such a coupling experiences theoretical and experimental coupling losses of 5.1 dB and 6.8 dB, respectively, with a limited operating bandwidth of 60 nm. Grating couplers also demand relatively long (>100 μm) adiabatic silicon waveguide tapers for horizontal waveguide expansion for efficient power transmission from nanowire (e.g. 400 nm) waveguides to 10 μm wide grating couplers, which require additional space on the photonic chip. Grating solutions also require high precision single mode fiber placement relative to the photonic chip for out-of-plane (surface) coupling, demanding vertical device space to allow space for single mode fiber bundles with large (e.g. >20 mm) minimum bend radius.

Edge-coupling of devices is desirable to minimize photonic chip and packaging footprint requirements and improve broadband functionality. Silicon-based tapers on the photonic chips have been used as modal expansion devices for reducing coupling losses with external devices. Vertical-stepped and multi-layer silicon waveguide tapers physically expand the waveguide dimensions and its fundamental mode size before interfacing with single mode fibers. Low loss converters may transform silicon wire waveguides into large cross-section silicon waveguides for improved (e.g., 3.3 dB) mode conversion and coupling efficiency with single mode fibers. However, these devices often require complex or non-CMOS compatible manufacturing steps for on-chip device incorporation.

Another example of an edge-coupling method for silicon photonics utilizes inverse tapers. Inverse tapers delocalize the propagating mode by adiabatically tapering down the core allowing the mode to expand into a surrounding material, either organic or inorganic, in the form of a large (e.g., >3 μm) core dielectric waveguide. In one example, low index waveguides (e.g., 3 μm×3 μm) were shown to exhibit a 2.5 dB coupling with 9.5 μm single mode fibers. However, inverse tapers require high quality and high resolution fabrication to adiabatically shape the silicon waveguide taper down to the desired dimensions (e.g., <100 nm with relatively long >100 μm inverse taper lengths). Furthermore, incorporating the large core dielectric waveguides creates topography restrictions and complicates the additional fabrication steps required on-chip.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

In one aspect, a tapered optical waveguide includes a tapered waveguide section formed of a polymer. The tapered waveguide section has an optical fiber coupling end and a waveguide coupling end opposite the optical fiber coupling end with each of the optical fiber coupling end and the waveguide coupling end being generally planar. The optical fiber coupling end has a larger area than the waveguide coupling end to define a horizontal and vertical taper between the optical fiber coupling end and the waveguide coupling end.

In another aspect, an optical system includes an optical fiber having a fiber end face and an optical chip including a substrate and at least one planar waveguide. The planar waveguide includes a planar waveguide end face having a smaller area than the fiber end face of the optical fiber. A polymer tapered waveguide includes a tapered waveguide section formed of a polymer and includes a horizontal taper and a vertical taper. The tapered waveguide has an optical fiber coupling end and a waveguide coupling end opposite the optical fiber coupling end. The waveguide coupling end is generally planar and the optical fiber coupling end has a larger area than the waveguide coupling end. The optical fiber coupling end of the tapered waveguide is optically coupled to the fiber end face of the optical fiber and the waveguide coupling end of the tapered waveguide is optically coupled to the waveguide end face of the planar waveguide.

### BRIEF DESCRIPTION OF THE DRAWINGS

FIG. 1 illustrates a perspective view of an optical system incorporating the tapered polymer waveguide disclosed herein;

FIG. 2 illustrates an exemplary graph of a simulation of a simulated mode width in a tapered polymer waveguide as a function of NA and taper width;

FIG. 3 illustrates a perspective view of a first embodiment of a tapered polymer waveguide;

FIG. 4 illustrates a side view of the optical system of FIG. 1 with the optical chip and optical fibers in phantom;

FIG. 5 illustrates a perspective view of a second embodiment of a tapered polymer waveguide;

FIG. 6 illustrates a perspective view of a third embodiment of a tapered polymer waveguide;

FIG. 7 illustrates an exemplary graph of a simulation of taper loss as a function of taper width and taper length for polymer waveguides having vertical tapers;

FIG. 8 illustrates an exemplary graph of a simulation of taper loss as a function of taper width and taper length for polymer waveguides having multi-layer tapers;

FIG. 9 illustrates an exemplary graph of a simulation of directional taper loss as a function of taper length;

FIG. 10 illustrates an exemplary graph of a simulation of coupling loss between silicon wire waveguides and single mode optical fibers coupled by multi-layer tapered polymer waveguides as a function of taper height and taper width;

FIG. 11 illustrates an exemplary graph of a simulation of coupling loss between silicon wire waveguides and single mode optical fibers coupled by vertical tapered polymer waveguides as a function of taper height and taper width;

FIG. 12 illustrates an exemplary graph of a simulation of coupling loss between silicon rib waveguides and single mode optical fibers coupled by multi-layer tapered polymer waveguides as a function of taper height and taper width;

FIG. 13 illustrates an exemplary graph of a simulation of coupling loss between silicon rib waveguides and single mode optical fibers coupled by vertical tapered polymer waveguides as a function of taper height and taper width;

FIG. 14 illustrates an exemplary graph of a simulation of coupling loss between silicon wire waveguides and single mode optical fibers coupled by vertical tapered polymer waveguides as function of taper width and horizontal taper misalignment;

FIG. 15 illustrates an exemplary graph of a simulation of coupling loss between silicon wire waveguides and single mode optical fibers coupled by vertical tapered polymer waveguides as function of taper height and vertical taper misalignment;

FIG. 16 illustrates an exemplary graph of a simulation of coupling loss between silicon rib waveguides and single mode optical fibers coupled by vertical tapered polymer waveguides as function of taper width and horizontal taper misalignment;

FIG. 17 illustrates an exemplary graph of a simulation of coupling loss between silicon rib waveguides and single mode optical fibers coupled by vertical tapered polymer waveguides as function of taper height and vertical taper misalignment;

FIG. 18 illustrates the mode profiles of TE₀ and TM₀ through an asymmetrical air, core, and gold waveguide;

FIG. 19 illustrates a schematic depiction of a measurement system for use while testing the tapered polymer waveguides; and

FIG. 20 illustrates a schematic depiction of a measurement system for use while testing the tapered polymer waveguides coupled to the silicon waveguides.

### DETAILED DESCRIPTION

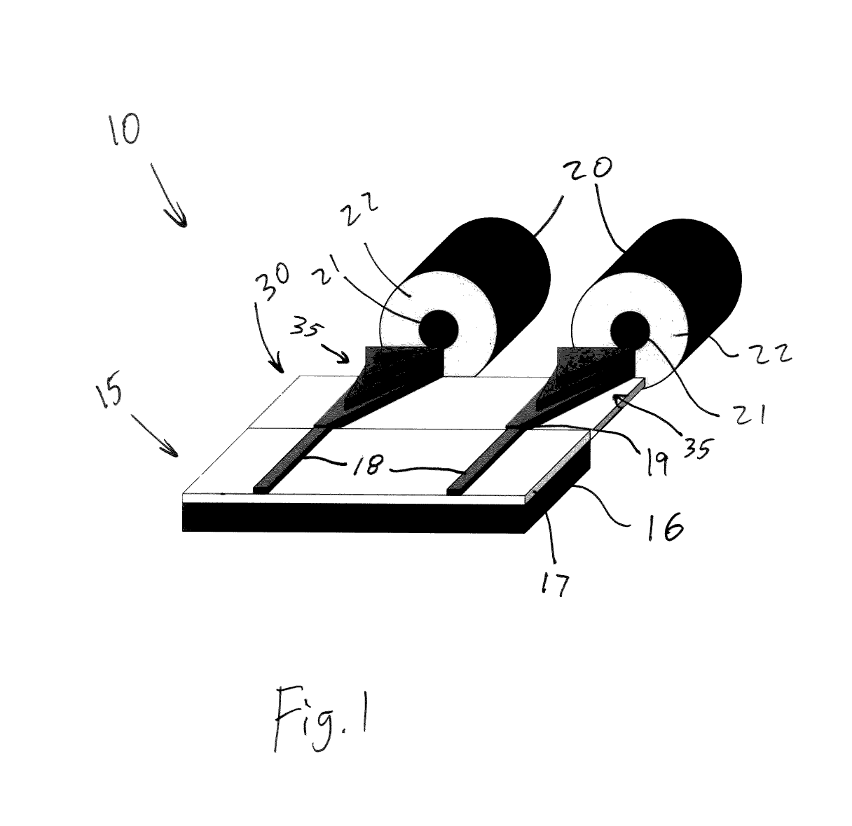

Referring to FIG. 1, an optical system 10 is depicted including a silicon optical or photonic chip 15 coupled to a pair of single mode optical fibers 20 through a polymer bridge module 30 having a pair of tapered polymer waveguides 35. It should be noted that the optical fibers 20 are depicted as being spaced from the polymer bridge module 34 clarity. The optical chip 15 includes a substrate 16, a cladding layer 17, and a plurality of planar waveguides 18 having a generally constant cross-section. In one example, the substrate 16 and the planar waveguides 18 may be formed of silicon (Si), and the cladding layer formed of silica (SiO₂) so that the cladding layer has a much lower index of refraction than that of the waveguides. In one example, the refractive index of the cladding layer 17 may be approximately 1.5, the refractive index of the silicon planar waveguides 18 may be approximately 3.5, and the cross-section of the silicon planar waveguides 18 may be generally rectangular and have a width of approximately 0.4 μm and a height of approximately 0.2 μm. As best seen in FIG. 4, the end face 19 of the planar waveguide may be configured as a planar surface that is co-planar with an end or edge surface 16a of the substrate 16 and/or an end or edge surface 17a of the cladding layer 17.

The single mode optical fibers 20 include a core 21 of silica, with a refractive index of approximately 1.5, surrounded by a concentric cladding layer 22, typically of a similar material, having a refractive index lower than that of the core. In one embodiment, the core may have a diameter of approximately 8-10 μm and the cladding may have a diameter of approximately 125 μm. The end face 23 of the core 21 may be configured as a planar surface.

Polymer bridge module 30 is provided to compensate for the mode size mismatch between the silicon waveguides 18 and the cores 21 of the optical fibers 20. To do so, the polymer bridge module 30 includes a polymer tapered waveguide 35 positioned between each aligned pair of waveguide 18 and optical fiber 20 that operates to efficiently couple the waveguide and its aligned optical fiber.

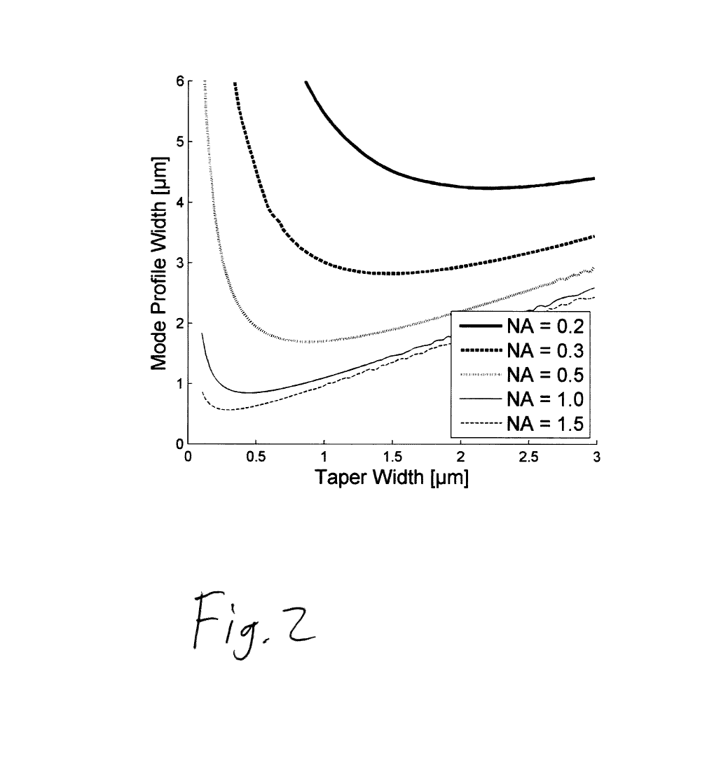

Coupling efficiency, Γ_{C}, between two optical waveguides structures is calculated using an overlap integral between the two mode profiles, as follows:

$${Γ}_{C} = \frac{\vert \int \int {E}_{in} ( x , y ) {E}_{out}^{*} ( x , y ) d y d x {\vert}^{2}}{\int \int \vert {E}_{in} ( x , y ) {\vert}^{2} d x d y \int \int \vert {E}_{out} ( x , y ) {\vert}^{2} d x d y} \qquad ( 1 )$$

where Eᵢₙ is the irradiance input and Eₒᵤₜ is the irradiance output. Waveguide tapers implement a simplistic mode-expander to improve modal overlap with the waveguide devices by slowly transforming the fundamental mode as it propagates through the device. The capability of a polymer tapered waveguide to efficiently condense optical power to acquire significant overlap with a silicon waveguide is determined by its numerical aperture (“NA”). Tapers with a high NA (≧1.0) are required to acquire strong (<1 μm mode profile width) modal confinement at the taper tip for effective overlap with the concentrated mode output of silicon waveguides as shown in the simulation of FIG. 2. In such simulation, the tapered region is surrounded by reflective metals or low dielectric materials to maintain a high NA and ensure modal confinement at sub-micron dimensions throughout the taper. While acting as a mode conversion device, the polymer tapered waveguides (NA˜1.1) still exhibit coupling loss at both end-faces with silicon waveguides (NA˜3.1) and single mode optical fibers (NA˜0.1).

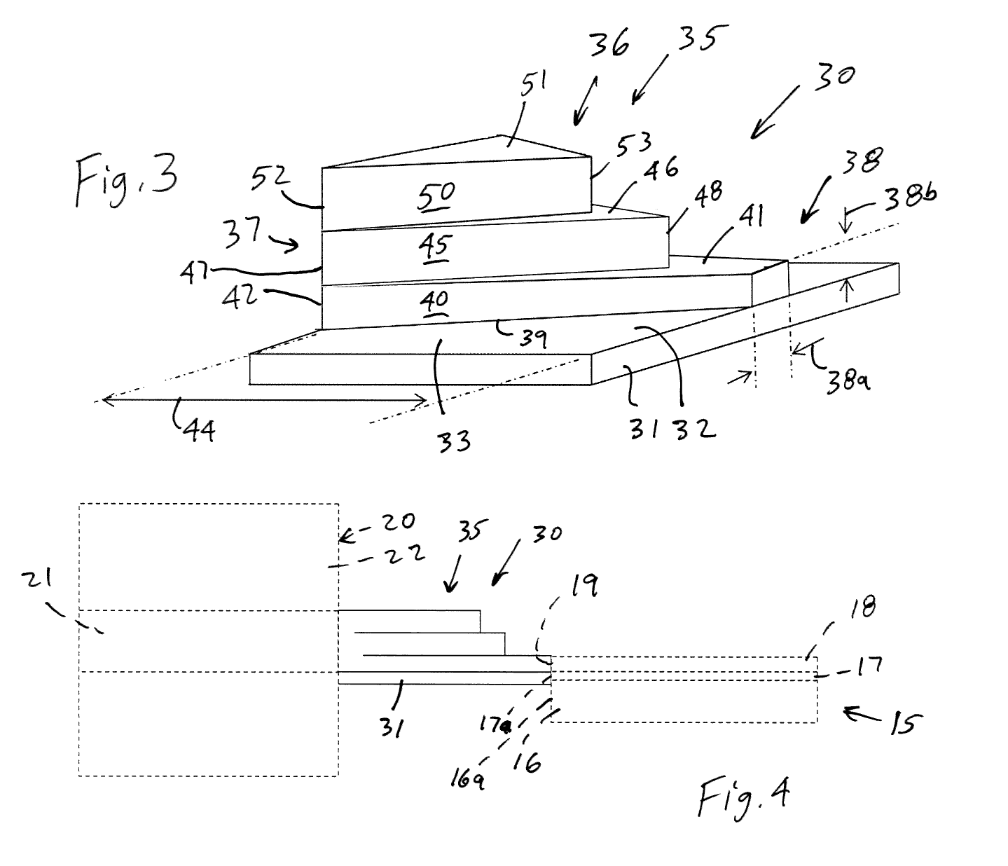

Referring to FIGS. 3-4, the polymer bridge module 30 includes a substrate 31 with a stepped or multi-layer tapered polymer waveguide 35. The substrate 31 may be coated with a highly reflective material 33 such as metal (e.g., gold) along the surface 32 on which the tapered polymer waveguides 35 are positioned or only at the positions at which the waveguides are located. The reflective surface 32 is provided to improve reflection within the tapered waveguide 35 along the lower surface thereof.

The tapered waveguide 35 has a tapered waveguide section 36 with a first or optical fiber coupling end 37 and a second or waveguide coupling end 38 opposite the first end. The optical fiber coupling end 37 may be generally rectangular and configured so that its cross-section generally matches the diameter of the core 21 of the optical fiber 20. In one example, the optical fiber coupling end may have a width of approximately 6 μm and a height of approximately 6 μm. Other dimensions may be used as desired. The waveguide coupling end 38 may be configured so that it generally matches the size of the waveguide 18. In one example, the waveguide coupling end may have a taper width 38a of approximately 500 nm and a taper height 38b of approximately 600 nm. Other dimensions may be used as desired and may be dependent upon the size and type of silicon waveguide 18, and the desired alignment tolerances and assembly procedures being used.

The tapered waveguide section 36 includes a plurality of vertically stepped, horizontally tapered sections or layers that operate to adiabatically taper the coupled mode between each pair of aligned silicon waveguide 18 and optical fiber 20. More specifically, the tapered waveguide section 38 includes a first or base layer 40 adjacent the reflective surface 32 of the substrate 31, a second or intermediate layer 45 above the base layer 40, and a third or upper layer 50 above the intermediate layer. A different number or layers may be utilized if desired.

Each of the layers has an upper surface that is generally parallel to the lower surface 39 of the tapered waveguide section 38 and the substrate 31. In addition, each of the layers horizontally tapers so that it is widest at its end towards or adjacent the optical fiber coupling end 37 and narrowest towards the waveguide coupling end 38. However, each of the layers horizontally tapers more rapidly (i.e., is shorter along the axis of light transmission) as the layers move upward from the substrate 31.

Base layer 40 has an upper surface 41, is widest at its optical fiber coupling end 42, and is narrowest at its generally rectangular waveguide coupling end 43. The generally rectangular waveguide coupling end 43 corresponds to the waveguide coupling end 38. The length 44 of the base layer 40 defines the taper length of the tapered waveguide section 36.

Intermediate layer 45 has an upper surface 46, is widest at its optical fiber coupling end 47, and is narrowest at tapered end 48. The tapered end 48 is spaced from the waveguide coupling end 38 towards the optical fiber coupling end 37. The upper layer 50 has an upper surface 51, is widest at its optical fiber coupling end 52, and is narrowest at tapered end 53. Tapered end 53 is located between the optical fiber coupling end 37 and the tapered end 47 of the intermediate layer 45. The optical fiber coupling end 42 of base layer 40, the optical fiber coupling end 47 of intermediate layer 45, and the optical fiber coupling end 52 of upper layer 50 are coplanar and define the optical fiber coupling end 37 of the tapered waveguide section 36.

The lower surface of the 39 of the tapered waveguide 35 corresponds to the lower surface of the base layer 40. If desired, rather than applying the reflective material to the substrate 31, the reflective material could be applied to the lower surface 39 of the tapered waveguide 35. In one example, if the tapered waveguide 35 were not mounted on substrate 31, the reflective material 33 could be applied directly to the lower surface of the tapered waveguide.

The tapered waveguide 35 may be formed as a one-piece integral component of any suitable optical grade polymer capable of being formed into the desired shaped. The tapered waveguide 35 may have an index of refraction generally matching that of the core 21 of optical fiber 20 in order to reduce reflection and other consequences of differences in the indices of refraction. In one example, the tapered waveguide 35 may have an index of refraction of approximately 1.50. Examples of optical grade polymers materials from which tapered waveguide 35 may be formed include acrylic-based materials, polyimides, siloxanes, epoxies, and organic/inorganic material hybrids.

In use, the tapered waveguide 35 may be surrounded by air on three sides and include a reflective material along its lower surface. Accordingly, by configuring the tapered waveguide 35 in a desired or optimal manner (i.e., with an adiabatic taper), light transmitted between a waveguide 18 and an optical fiber 20 through the tapered waveguide in an efficient manner based upon total internal refection along the air/waveguide boundary and based upon reflection by the reflective material 33 along the lower surface 39 of the waveguide. Optical losses may be reduced or minimized by using a refractive index-matching medium as is known in the art to optically couple or connect the planar waveguide 18 and the optical fiber 20 to their respective ends of the tapered waveguide 35. If desired, a refractive index-matching adhesive may be used to optically and mechanically connect the planar waveguide 18, the optical fiber 20, and the tapered waveguide 35.

Various modifications to the multi-layer tapered polymer waveguides 35 are contemplated. In one example, rather than including the reflective material along the lower surface 39, the lower surface may be surrounded by or contact air or another material having a lower refractive index than that of the tapered waveguide 35. In order to create an air/lower surface 39 boundary, additional mounting structures (not shown) are contemplated to support each optical chip 15, optical fiber 20, and tapered waveguide 35 combination.

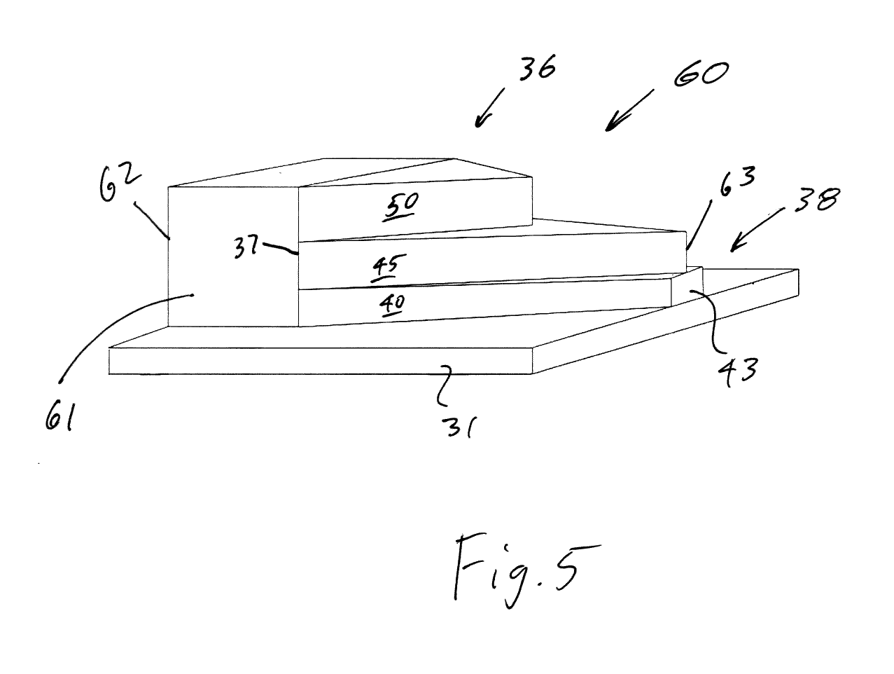

In another example of a modification to the multi-layer tapered polymer waveguides 35, a generally rectangular portion having a constant cross-sectional area may extend from either or both ends of the tapered waveguide section 36. For example, referring to FIG. 5, an alternate embodiment of a tapered polymer waveguide 60 is depicted in which like references numbers identify like components. The tapered polymer waveguide 60 further includes a generally rectangular section 61 that extends from the optical fiber coupling end 37 of the tapered waveguide section 36 away from the waveguide coupling end 38 and terminates at an optical fiber coupling end 62 of the tapered polymer waveguide 60. As such, the rectangular portion 61 increases the length of the tapered polymer waveguide 60.

Still another example of a modification to the tapered polymer waveguides 35 includes changes to the lengths of the intermediate layer 45 and the upper layer 50 of the tapered waveguide section 36. As depicted in FIG. 5, the tapered end 63 of the intermediate layer 45 of the tapered waveguide portion 36 extends to the waveguide coupling end 38.

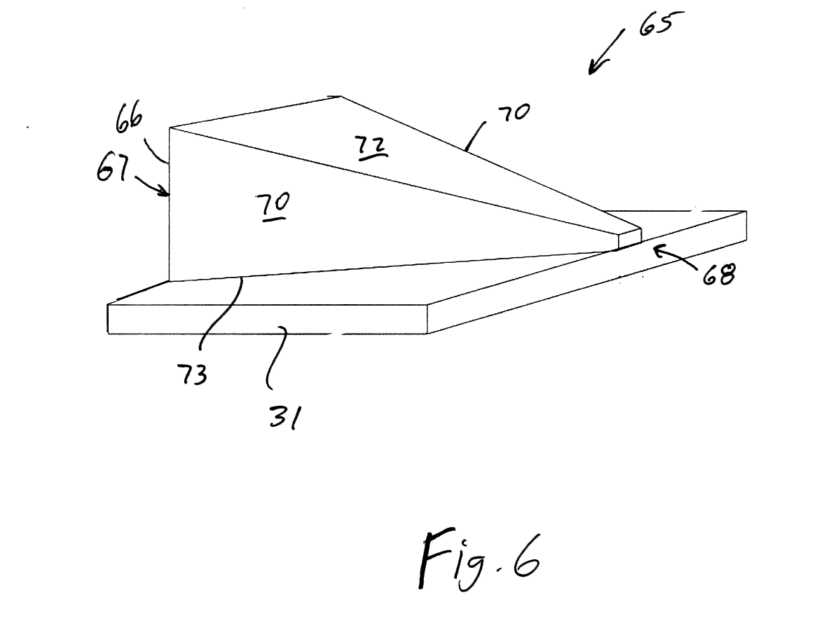

In an alternate embodiment depicted in FIG. 6, a tapered polymer waveguide 65 includes a tapered waveguide section 66 having both vertically and horizontally tapered surfaces. The tapered waveguide section 66 extends from a first or optical fiber coupling end 67 of the tapered waveguide section to a second or waveguide coupling end 68, opposite the first end. The tapered waveguide section 66 includes converging sidewalls 70 (i.e., tapering both horizontally and vertically) to define the horizontal taper of the tapered polymer waveguide 65 and an upper surface or wall 72 that defines the vertical taper. In other words, rather than creating a vertical taper using the multiple layers of tapered waveguide 35, the tapered section 66 vertically tapers in a smooth manner and is sometimes referred to herein as a vertical taper polymer waveguide.

As with the lower surface of the 39 of the tapered polymer waveguide 35, it is desirable for the lower surface 73 of the tapered polymer waveguide 65 to be reflective. This may be accomplished by applying a reflective material 33 to the lower surface 73, by mounting or forming the tapered polymer waveguide 65 on a surface 32 of substrate 31 having a reflective material thereon, or by creating an interface between the lower surface and another material (e.g., air) having a lower refractive index.

Other than the manner in which the vertical taper is formed, tapered polymer waveguide 65 may be formed, implemented, and used in a manner generally identical to the tapered polymer waveguide which includes the plurality of vertically stepped, horizontally tapered layers 40, 45, 50.

In still another alternate embodiment, the tapered polymer waveguide may include a tapered waveguide section having an arcuate outer surface that tapers from the optical fiber coupling end to the waveguide coupling end. Such arcuate tapered waveguide section functions in the manner described above with respect to tapered polymer waveguides 35, 65 but does not depict specific sidewalls and one or more top or upper surfaces but one skilled in the art would recognize that portions of the arcuate three-dimensional configuration operate as the horizontally tapered sidewalls and the tapered upper surface.

The design and application or use of tapered polymer waveguides includes the consideration of various factors including taper length, taper tip dimensions, and misalignment tolerances. Mode conversion design performance for both the multi-layer tapered polymer waveguide 35 and the horizontally and vertically tapered polymer waveguide 65 was simulated using the beam propagation method (“BPM”). The refractive index of the polymer taper was set at 1.5142, the taper region set as being surrounded by air (n_{clad}=1), and the wavelength set at 1310 nm (TE polarization). Boundary reflections at the interfaces of the tapered polymer waveguide were not taken into account.

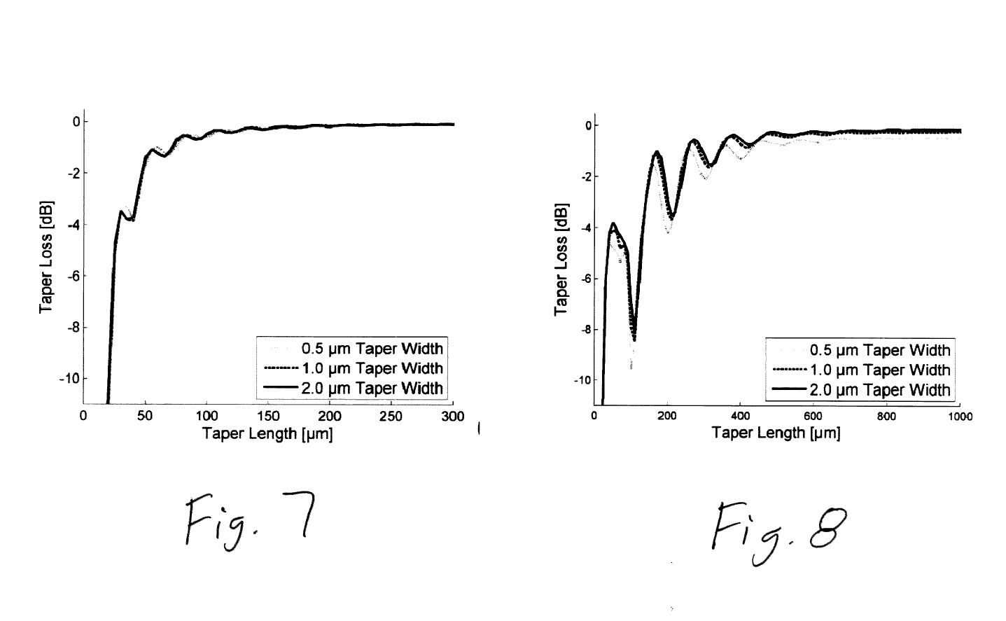

Tapered polymer waveguide devices require a minimum length to realize adiabatic mode conversion where the coupled mode is expanded without excitation to radiation, leaky, or higher-order modes. This overall dependence between coupling loss and taper length utilizing a 0.5 μm taper height 38b is depicted in FIG. 7 for the vertical tapers (i.e., tapered waveguide 65) and in FIG. 8 for the multi-layer tapers (i.e., tapered waveguide 35).

From FIGS. 7-8, it will be understood that adiabatic length requirements are dependent upon taper design but independent of taper tip dimensions. More specifically, the minimum taper lengths 44 to achieve adiabatic mode conversion for vertical tapers and multi-layer tapers are 200 μm and 600 μm, respectively. The length requirement with the multi-layer taper is significantly longer due to the modal transformation between the multiple stacked tapered layers. Shorter multi-layer taper lengths result in the excitation of vertical higher-order modes from self-imaging resulting in increasing variations in taper loss as the taper length is decreased. The multi-layer taper design such as waveguide 35 was observed to require at least three layers for efficient mode conversion. Negligible improvements in coupling efficiency were observed if more than three layers were incorporated.

Simulations using a 0.5 μm taper height 38b were also performed to determine coupling symmetry along the tapered polymer waveguides. More specifically, simulations were performed to determine whether the coupling loss through the tapered polymer waveguides 35, 65 from the single mode optical fibers 20 to the silicon waveguides 18 (i.e., mode condensing) is identical to the coupling loss from the silicon waveguides to the single mode optical fibers (i.e., mode expanding). FIG. 9 depicts a simulation using a multi-layer taper such as waveguide 35 with a 0.5 μm taper width 38a and a 0.5 μm taper height 38b at λ=1310 nm. From the simulation, the tapered polymer waveguide exhibits minimal (0.2 dB) variations in taper loss at adiabatic taper lengths.

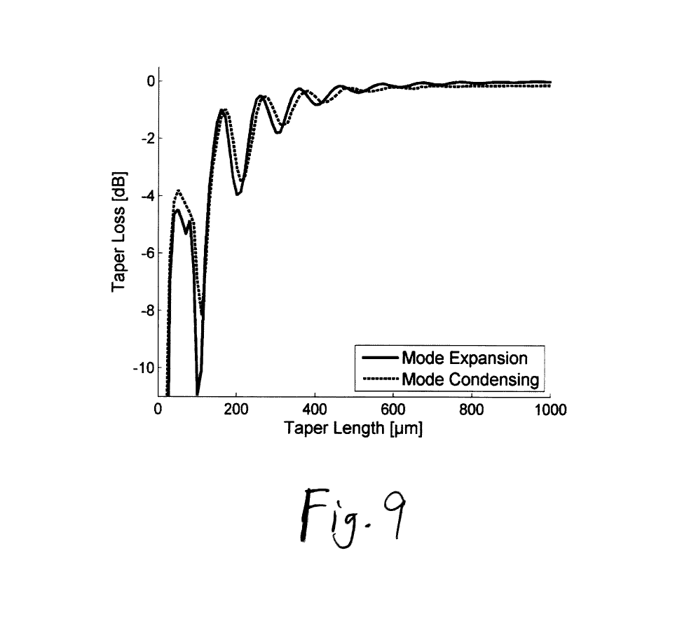

Simulations were also conducted for determining the impact on the coupling efficiency between a tapered polymer waveguide and a silicon planar waveguide 18 based upon the dimensions of the waveguide coupling end of the tapered polymer waveguide. In the simulation, single mode profiles of both silicon wire waveguides (200 nm×350 nm) and silicon rib waveguides (200 nm×1000 nm, 25 nm rib height) were used as launch fields to demonstrate the tapered polymer waveguide's compatibility with both the silicon wire waveguides and the silicon rib waveguides. The tapered polymer waveguide was set to expand to single mode (6 μm×6 μm) to maximize coupling efficiency with a single mode optical fiber. As may be seen in FIGS. 10-13, various tip dimensions were utilized for the waveguide coupling end of the tapered polymer waveguide.

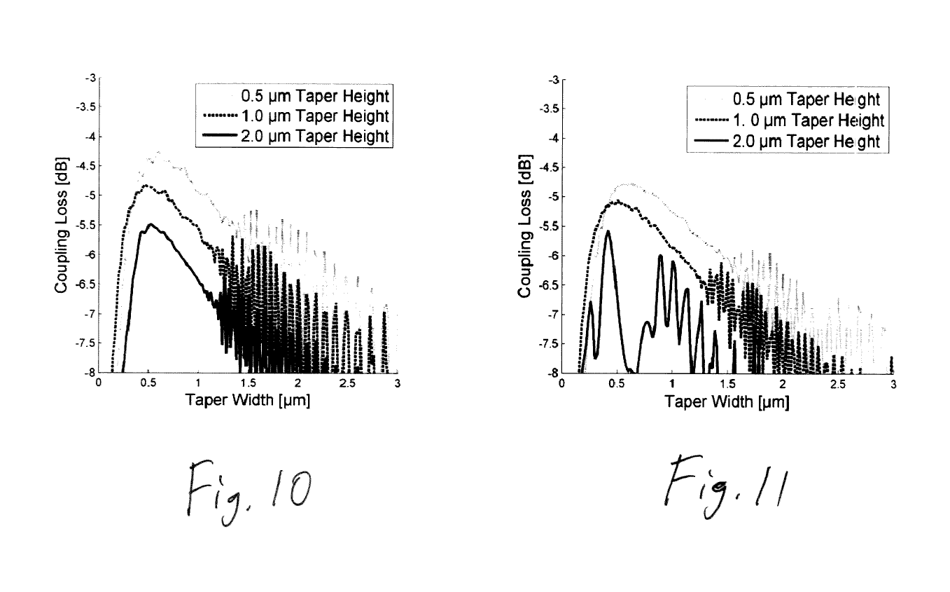

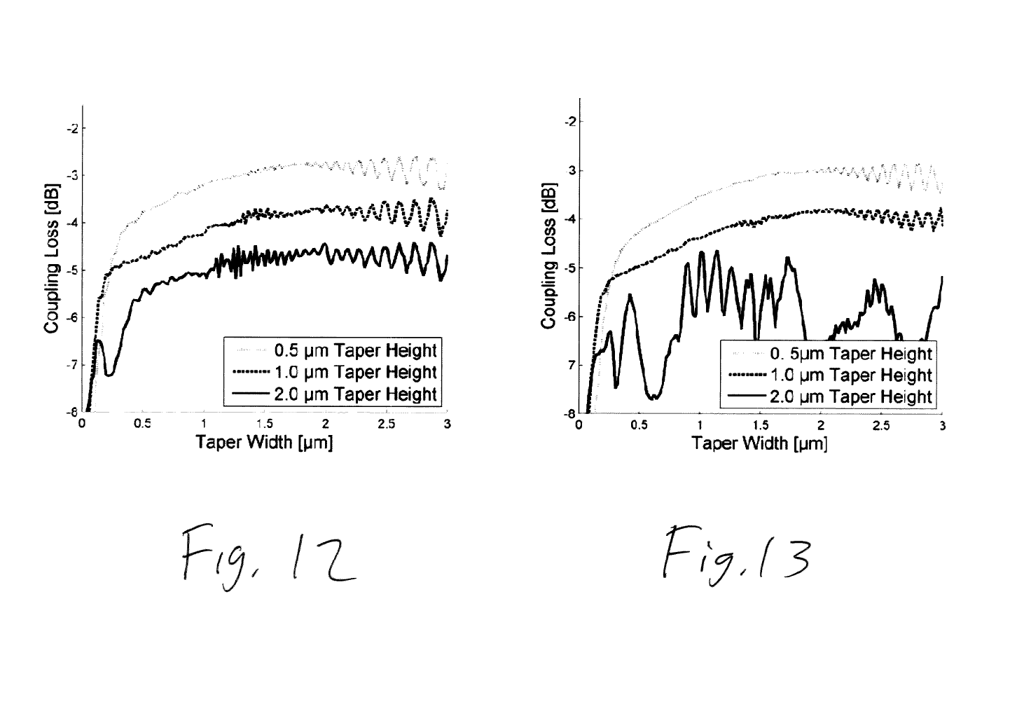

FIG. 10 depicts the coupling loss between a silicon wire waveguide and a single mode optical fiber utilizing a vertical taper in the tapered polymer waveguide, and FIG. 11 depicts the coupling loss between a silicon wire waveguide and a single mode optical fiber utilizing a multi-layer taper the tapered polymer waveguide. FIG. 12 depicts the coupling loss between a silicon rib waveguide and a single mode optical fiber utilizing a vertical taper in the tapered polymer waveguide, and FIG. 13 depicts the coupling loss between a silicon rib waveguide and a single mode optical fiber utilizing a multi-layer taper in the tapered polymer waveguide.

From the simulation, it was determined that the dimensions required for optimal coupling is dependent upon the type and size of the silicon waveguide and its resulting mode profile. From FIGS. 10-11, it may be understood that the coupling efficiency between a silicon wire waveguide and a single mode optical fiber utilizing a tapered polymer waveguide is maximized with a 500 nm×600 nm polymer waveguide taper tip. In contrast, coupling efficiency is maximized with a 2 μm taper width 38a when used with a silicon rib waveguide, as shown in FIGS. 12-13). The larger mode profile of the silicon rib waveguide (2.75 dB) exhibits lower coupling loss in comparison to the silicon wire waveguide (4.25 dB).

In addition, coupling differences between taper designs were observed with larger taper widths 38a. Expanding the dimensions of the taper tip increased the amount of higher-order modal excitation and raised the amount of self-imaging effects within the taper. This is observed as significant fluctuations in optical coupling as can be seen with relatively wide (>2 μm) taper widths. Multi-layer tapers are more sensitive to multi-mode coupling resulting in lower and more inconsistent coupling efficiencies with 2 μm height tapers, as shown in FIG. 11 and FIG. 13.

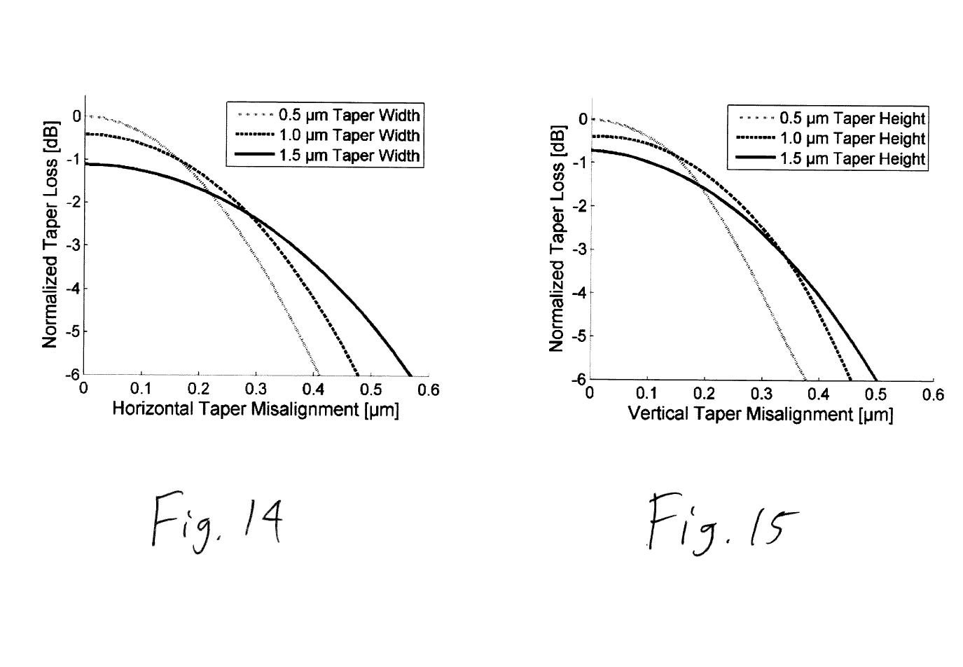

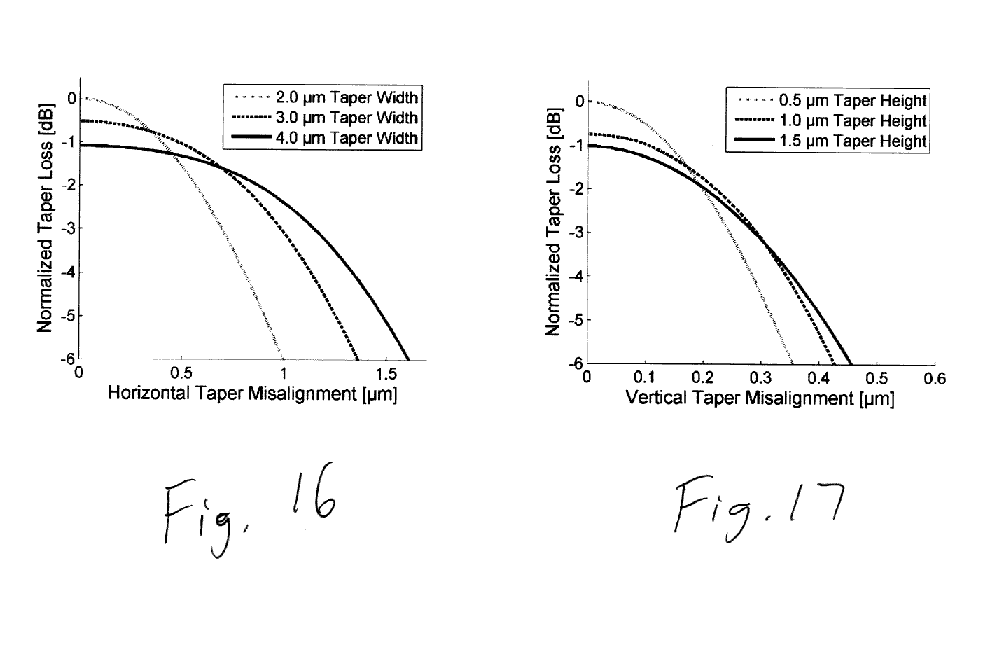

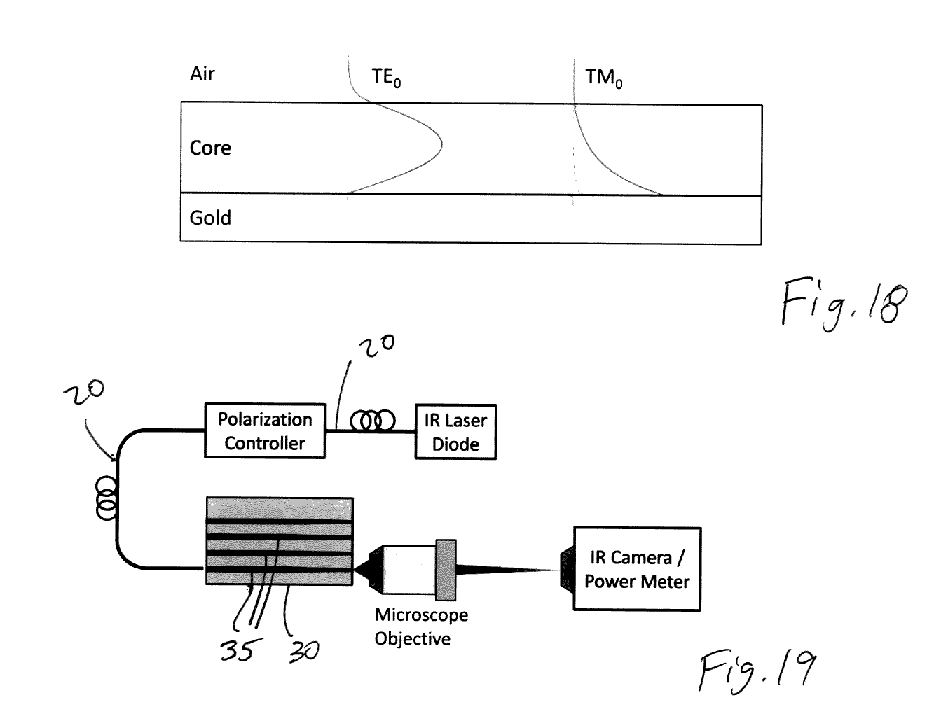

Simulations of normalized misalignment losses between tapered polymer waveguides and silicon waveguides are shown in FIGS. 14-17 with a simulated wavelength of λ=1310 nm. In FIG. 14, the taper height 38b was set at 0.5 μm and in FIG. 15, the taper width 38a was set at 0.5 μm, and in both instances, the silicon waveguide 18 was a silicon wire waveguide. In FIG. 16, the taper height 38b was set at 0.5 μm and in FIG. 17, the taper width 38a was set at 2.0 μm, and in both instances, the silicon waveguide 18 was a silicon rib waveguide. Each of the tapered polymer waveguides had similar normalized misalignment curves as coupling loss was observed as a function of taper tip dimensions controlling the output mode profile and independent of taper design utilized for mode size conversion.

Increasing the taper width 38a relaxes the device alignment tolerances at the cost of reducing the maximum coupling efficiency. Tapered polymer waveguides with a 0.5 μm taper width 38a exhibit relatively tight (3 dB) misalignment tolerances (±0.3 μm) when coupled with silicon wire waveguides. Increasing the taper width 38a to 1.5 μm improves the 3 dB misalignment tolerances (±0.4 μm) with silicon wire waveguides. When coupling with silicon rib waveguides, increasing the taper width 38a from 2 μm to 4 μm increases the 3 dB misalignment tolerances from ±0.7 μm to ±1.2 μm. Additional widening of the taper width 38a results in decreased and inconsistent coupling efficiency due to multi-modal excitation.

A metallic-coated substrate 31 may be used as a lower cladding for the tapered waveguides 35, 65 to ensure efficient coupling with high NA silicon waveguides 18 while eliminating substrate radiation. Propagation loss for a metal-clad polymer waveguide will experience polarization-dependent loss due to absorption of the evanescent wave in the metal. Attenuation of the TE₀ mode from a gold lower-cladding is high (260 dB/cm, λ=1310 nm) for small (0.5 μm) waveguide taper heights 38b and decreases exponentially as the waveguide height is increased.

The TM₀ mode couples to the surface plasmon wave and mostly resides at the metal-dielectric boundary resulting in extremely high (˜1650 dB/cm, λ=1310 nm) attenuation independent of waveguide dimensions. Both mode profiles are illustrated in FIG. 18. For this reason, metal-clad waveguides have been used in integrated optics as polarization filters with high extinction ratios. In some applications, metallic-bottom clad polymer waveguide tapers may be desirable for TE mode conversion due to the high absorption loss of TM polarized light from plasmonic coupling. Shallow-etched silicon rib waveguides inherently propagate the TE₀ mode with low loss allowing for polarization compatibility with metallic-bottom tapers.

It may be desirable to set the taper length 44 of a tapered waveguide 35, 65 with a gold-bottom clad to minimize taper device loss. In some applications, it may be desirable to set the polymer taper length 44 close to the adiabatic length constraint to balance both adiabatic taper loss and propagation loss from metallic absorption. Multi-layer tapers such as those of tapered waveguide 35 may also be fabricated with the middle taper length equal to the total taper length, as illustrated FIG. 5 to reduce additional loss (≧90 dB/cm) while propagating through a sub-micron (≦1 μm) waveguide height.

Based upon the simulation depicted in FIG. 8, it is believed that a minimum taper length 44 of approximately 600 μm is required for a tapered polymer waveguide 35 with a multi-layer taper to achieve adiabatic mode conversion. However, shorter lengths may be acceptable in some systems. In some applications, a taper length 44 of at least 400 μm may be desirable as such a minimum taper length would result in a loss of less than approximately 1 dB. In other applications, a taper length 44 of at least 160 μm may be desirable as such a minimum taper length would result in a loss of less than approximately 3 dB. The taper length 44 may be set based upon system requirements and losses of other components with the system.

Based upon the simulation depicted in FIG. 7, it is believed that a minimum taper length of approximately 200 μm is required for a tapered polymer waveguide 65 with a vertical taper to achieve adiabatic mode conversion. However, shorter lengths may be acceptable in some systems. In some applications, a taper length of at least 70 μm may be desirable as such a minimum taper length would result in a loss of less than approximately 1 dB. In other applications, a taper length of at least 40 μm may be desirable as such a minimum taper length would result in a loss of less than approximately 3 dB. As with the multi-layer taper, the taper length of the vertical taper may be set based upon system requirements and losses of other components with the system.

Empirical data was obtained by fabricating tapered waveguides from a polymer using photolithography and evaluated through optical testing to experimentally demonstrate practical functionality for both taper loss and coupling loss. The polymer tapered waveguides were first measured for taper loss to correlate with theoretical loss the associated metallic absorption and sidewall roughness scattering. Coupling loss between the polymer tapered waveguides and silicon waveguides 18 was measured and compared to theoretical coupling loss due to mode overlap and interface reflection.

The prototypes were fabricated from a UV-curable siloxane optical elastomer manufactured by Dow Corning®. The optical elastomer demonstrates low absorption loss at λ=850 nm (<0.04 dB/cm), λ=1310 nm (<0.4 dB/cm), and λ=1550 nm (<1.8 dB/cm).

The prototypes were formed using a multi-step photolithographic process. Tapers were fabricated on a gold sputtered silicon substrate to prevent substrate radiation modes. The overall taper design was 2 mm in length to ensure adiabatic modal expansion. The bottom layer utilized a diluted polymer solution to spin coat a 0.7 μm thick layer to maintain single mode functionality. This layer was patterned into 6 μm waveguides that taper down to 2 μm taper widths 38a. The second and third elastomer layers were spun to a thickness of 3 μm and 6 μm and patterned into overlying tapered waveguides of shorter lengths of 1.6 mm and 1.2 mm, respectively, to create a configuration similar to that depicted in FIG. 5. Multi-layer taper end-faces were prepared using traditional silicon wafer cleaving.

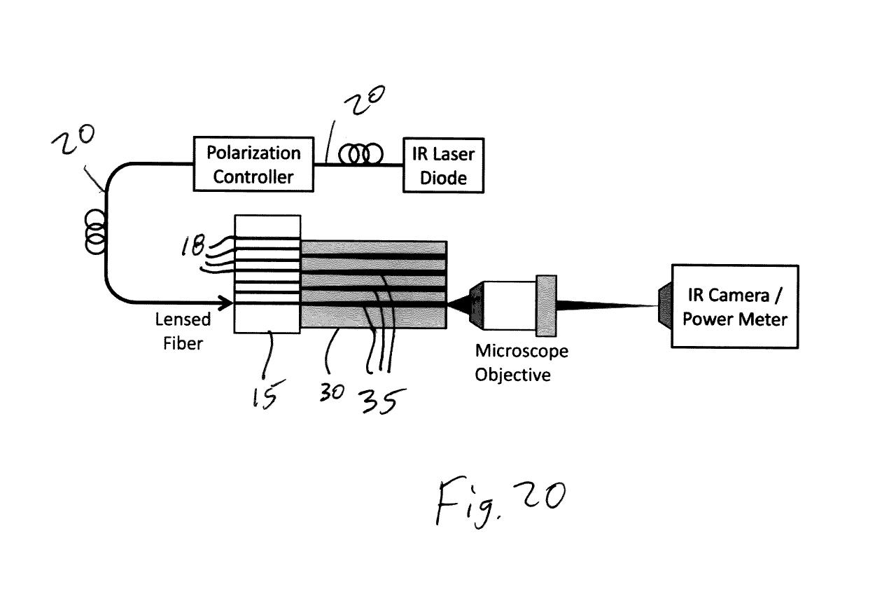

The device loss of multi-layer tapers was measured with TE polarized light at an operating wavelength of λ=1310 nm using the measurement system depicted in FIG. 19. The 6 μm taper end was end-fire coupled with a single mode optical fiber 20 and the output of the taper was captured with a microscope objective (NA=0.85) and measured using a Germanium (Ge) photodiode. Measured taper loss for an average of four polymer taper waveguides for TE polarized light was measured at 15.1±0.7 dB in comparison to simulated taper loss of 12.0 dB.

The polymer waveguide taper prototype will theoretically experience high (e.g., 4.9 dB) metallic absorption loss from the gold bottom cladding. Limitations in the precision of prototype cleaving resulted in the prototype tapered waveguides exhibiting a 0.7 μm waveguide height 38b that is 250 μm beyond the tapered end 63 in FIG. 5. This polymer waveguide region results in a theoretical gold absorption loss of 2.5 dB in addition to the 2.4 dB absorption loss in the polymer taper. Gold absorption loss in multi-layer tapers is reduced further (1.0 dB) when the taper length is manufactured at the adiabatic length (600 μm).

High-NA waveguides are more susceptible to scattering loss from the level of sidewall roughness resulting from the fabrication method. The sidewall roughness of polymer waveguides fabricated through photolithography has previously been measured at 48 nm RMS with a correlation length of 3 μm. BPM simulations estimate the scattering loss of the taper device at 7.1 dB.

Coupling loss between silicon waveguides 18 and the prototype polymer taper waveguide was also evaluated to validate high coupling efficiency at the interface between silicon waveguides and the polymer tapered waveguides using the measurement system depicted in FIG. 20. TE-polarized laser diode power (λ=1310 nm) was coupled into silicon wire waveguides (2 μm×0.215 μm) using a lensed single mode optical fiber 20 as an optical input. Index-matching fluid (n=1.512) was applied between actively aligned polymer tapered waveguides and silicon waveguides 18 to reduce boundary reflection and air-gap loss. Output power was coupled using a microscope objective (NA=0.85) and measured using a Ge photodiode.

Coupling loss between the polymer tapered waveguides and the silicon waveguides 18 was measured at 2.74±1.0 dB after taking into account the measured taper loss (15.1 dB) assuming symmetric modal propagation. This is comparable to the theoretical coupling loss of 2.48 dB due to the summation of mode overlap loss (Γ_{C}=1.72 dB) and theoretical Fresnel reflection loss (0.76 dB) at the silicon-polymer interface. Coupling loss due to interface reflection may be further reduced by utilizing appropriate index matching techniques and anti-reflection coatings at the silicon-polymer boundary.

Experimental results showed that polymer tapered waveguides exhibit exceptional coupling with silicon waveguides and the results follow theoretical and/or simulated findings.

Both multi-layer and vertical taper designs may be fabricated with one-step procedures utilizing master molds that eliminate alignment-based processing steps, improve taper sidewall roughness, and decrease overall design costs. Examples of manufacturing processes that may be used to manufacture one-piece integrally formed tapered polymer waveguides include soft imprint lithography, grey scale lithography, step-and-flash imprint lithography, e-beam lithography, and focused ion-beam processes. In an alternate process, UV-initiated waveguide polymers can be uniformly UV cured, pressed into the desired taper shape, and then thermally cured to complete polymerization without requiring a transparent mask.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A tapered optical waveguide comprising:
a tapered waveguide section formed of a polymer,
the tapered waveguide section having an optical fiber coupling end and a waveguide coupling end opposite the optical fiber coupling end;
each of the optical fiber coupling end and the waveguide coupling end being generally planar, and
the optical fiber coupling end having a larger area than the waveguide coupling end to define a horizontal and vertical taper between the optical fiber coupling end and the waveguide coupling end.

2. The tapered optical waveguide of claim 1, wherein the tapered waveguide section has a planar lower surface.

3. The tapered optical waveguide of claim 2, further including a reflective coating along the lower surface.

4. The tapered optical waveguide of claim 3, wherein the reflective coating is metallic.

5. The tapered optical waveguide of claim 3, further including a substrate, the lower surface of the tapered waveguide section being mounted on the substrate, the reflective coating being positioned between the substrate and the lower surface.

6. The tapered optical waveguide of claim 1, wherein the tapered waveguide section has a lower surface and the lower surface is contacted by air to define an air interface between the lower surface and the air.

7. The tapered optical waveguide of claim 1, wherein the tapered waveguide section includes a plurality of vertically stacked, horizontally tapered waveguide layers.

8. The tapered optical waveguide of claim 7, wherein the tapered waveguide section includes a planar lower surface, each waveguide layer includes a generally planar upper surface, each generally planar upper surface being parallel to the lower surface.

9. The tapered optical waveguide of claim 7, wherein the tapered waveguide section has a length of at least approximately 160 μm long.

10. The tapered optical waveguide of claim 1, wherein the tapered waveguide section includes a vertically tapered upper surface and horizontally and vertically tapered sidewalls.

11. The tapered optical waveguide of claim 10, wherein the tapered waveguide section has a length of at least approximately 40 μm long.

12. The tapered optical waveguide of claim 1, wherein the tapered optical waveguide is formed of an optical grade polymer.

13. The tapered optical waveguide of claim 1, wherein the tapered optical waveguide has an index of refraction of approximately 1.5.

14. The tapered optical waveguide of claim 1, wherein the tapered waveguide section has a three-dimensional configuration surrounded by air to define an air interface between the tapered waveguide section and the air.

15. The tapered optical waveguide of claim 14, wherein the three-dimensional configuration includes at least two horizontally tapered sides.

16. The tapered optical waveguide of claim 15, wherein the three-dimensional configuration includes a vertically tapered upper surface.

17. An optical system comprising:
an optical fiber having a fiber end face;
an optical chip including a substrate and at least one planar waveguide, the planar waveguide including a planar waveguide end face, the planar waveguide end face having a smaller area than the fiber end face of the optical fiber;
a polymer tapered waveguide including a tapered waveguide section formed of a polymer and including a horizontal taper and a vertical taper, the tapered waveguide having an optical fiber coupling end and a waveguide coupling end opposite the optical fiber coupling end, the waveguide coupling end being generally planar, the optical fiber coupling end having a larger area than the waveguide coupling end;
the optical fiber coupling end of the tapered waveguide being optically coupled to the fiber end face of the optical fiber; and
the waveguide coupling end of the tapered waveguide being optically coupled to the waveguide end face of the planar waveguide.

18. The optical system of claim 17, wherein the substrate includes a planar edge and the planar edge of the substrate and the waveguide end face are co-planar.

19. The optical system of claim 18, wherein the optical fiber is a single mode optical fiber and the optical chip includes a substrate layer, a cladding layer, and the planar waveguide is formed of silicon.

20. The optical system of claim 17, wherein the tapered waveguide section has a planar lower surface with a reflective coating along the lower surface.
